(19) United States
(12) Patent Application Publication
(10) Pub. No.: US 2015/0034748 A1
(43) Pub. Date: Feb. 5, 2015

(54) Zippy Shaker

(71) Applicant: Daniel Jackson Ortiz, providence, RI (US)

(72) Inventor: Daniel Jackson Ortiz, providence, RI (US)

(21) Appl. No.: 13/927,710

(22) Filed: Aug. 1, 2013

(51) Int. Cl. A47J 43/27; B02C 18/24

(52) U.S. Cl. CPC A47J 43/27; B02C 18/24
USPC 241/169.1

(57) ABSTRACT

There is provided a blending container for mixing a nutritional liquid including a cup for holding the liquid and having a base wall; a cover for a top of the cup; a strut constructed and arranged for positioning adjacent to the base wall; at least one blade supported from the strut; and a pulley mechanism disposed over the base wall of the cup and coupled to and for controlling a spinning of the strut.

### RELATED CASES

Priority for this application is hereby claimed under 35 U.S.C. §119(e) to commonly owned and co-pending U.S. Provisional Patent Application Nos. 61/810,445 which was filed on Apr. 10, 2013 and 61/828,863 which was filed on May 30, 2013 and each of which is incorporated by reference herein in its entirety.

### FIELD OF THE INVENTION

The present invention relates in general to a cup structure that can be used for containing a nutritional liquid. More particularly, the present invention relates to an improvement in a blender cup construction.

### BACKGROUND OF THE INVENTION

There presently exists cup constructions for holding different types of nutritional liquid drinks. Many times these products use a powder form mixed with a liquid thus requiring some shaking action. Any existing products may include some type of a mechanism at the top end of the cup. However, existing products do not provide any type of a shaking mechanism at the bottom end of the cup.

Accordingly, it is an object of the present invention to provide an improved blender cup construction.

Another object of the present invention is to provide a blender cup for making such drinks as smoothies or protein shakes without the need for buying an electronically controlled blending mechanism.

### SUMMARY OF THE INVENTION

To accomplish the foregoing and other objects, features and advantages blending container for mixing a nutritional liquid that includes a cup for holding the liquid and having a base wall; a cover for a top of the cup; a strut constructed and arranged for positioning adjacent to the base wall; and a plurality of blades supported from the strut.

In accordance with other aspects of the present invention each of the blades is supported to be spaced apart in a longitudinal direction between the cup and cover; each blade is supported in parallel with all other blades; all blades are planar and extend in parallel planes to the base wall of the cup; each blade is substantially rectangular in shape; each blade has rounded corners; including a pulley mechanism disposed over the base wall of the cup and for controlling a spinning of the strut; all blades are planar and are supported in parallel to each other; including a pull handle for controlling the pulley mechanism; including a string connected between the pulley mechanism and the pull handle; each of the blades is supported to be spaced apart in a longitudinal direction between the cup and cover; all blades are planar and extend in parallel planes to the base wall of the cup; each blade is substantially rectangular in shape; and each blade has rounded corners.

In accordance with another embodiment of the present invention there is provided a blending container for mixing a nutritional liquid including a cup for holding the liquid and having a base wall; a cover for a top of the cup; a strut constructed and arranged for positioning adjacent to the base wall; at least one blade supported from the strut; and a pulley mechanism disposed over the base wall of the cup and coupled to and for controlling a spinning of the strut.

In accordance with still other aspects of the present invention all blades are planar and are supported in parallel to each other; including a pull handle for controlling the pulley mechanism; including a string connected between the pulley mechanism and the pull handle; all blades are planar and extend in parallel planes to the base wall of the cup; each blade is substantially rectangular in shape, and each blade has rounded corners.

### BRIEF DESCRIPTION OF THE DRAWINGS

FIG. 1A is a front elevation view of a blender cup of the present invention;

FIG. 1B is a side elevation view of the blender cup;

FIG. 2A is a front view of the mixing or blending mechanism disposed at the bottom of the cup; and

FIG. 2B is a cross-sectional view taken along line 2B-2B of FIG. 2A.

### DETAILED DESCRIPTION

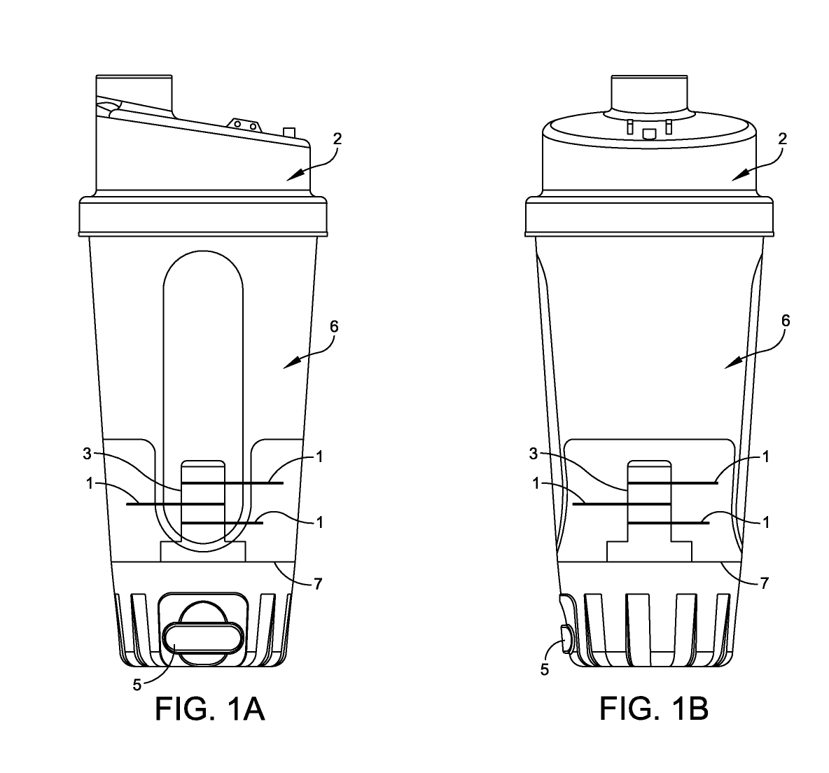

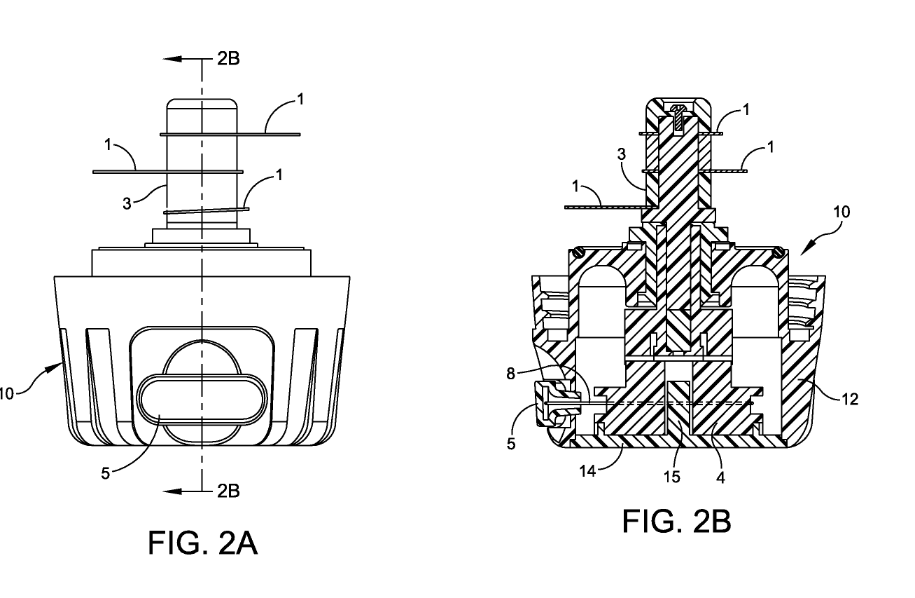

With reference to FIGS. 1A and 1B there is shown a cup 6 that may be substantially of conventional design. This is typically constructed of a plastic material. There is a lid 2 that is disposed on the top of a cup 6. The cup 6 may be of a transparent plastic material and thus there is viewed through the cup in FIGS. 1A and 1B the blending mechanism 10. Further details of the blending mechanism are detailed in FIGS. 2a AND 2b. As particularly shown in the cross-sectional view of FIG. 2B, there are provided three rectangular blades 1 with rounded corners. These blades may be constructed of a stainless steel material. The blades are attached to a strut 3 and these components are disposed at the base of the shaker cup. The strut and blades are controlled by a resistance pulley mechanism 4 that is adapted to spin as one pulls on the handle 5. The handle 5 controls the pulley mechanism by way of a spring 8. To create momentum, the blades spin at high speeds by the force of the pulling action imposed by pulling the handle 5 and spinning the pulley mechanism 4. This arrangement can grind fruit/vegetables to create a protein or nutritional drink

As illustrated in FIG. 2B, the mechanism 10 is disposed at a bottom end of the cup 6. FIG. 2A also shows the handle 5 that is disposed outside of the bottom of the cup and accessible so as to be pulled away from the cup. This causes an increased momentum enabling the blade to spin and grind fruit or vegetables into a protein powder.

A user can manually pull on the handle 5 to create a momentum so as to spin the three rectangular blades 3. This arrangement makes it easier for the consumer without spending substantial sums for including an electronic spinning arrangement or a battery operated arrangement. The fruit or vegetable components can thus be ground manually using one's own pulling power.

One feature of the present invention is that there is no need for batteries nor any need to plug the cup into an electrical source. Instead, manual operation is possible to yield the desired drink.

Having now described a limited number of embodiments of the present invention, it should now be apparent to those skilled in the art that numerous other embodiments and modifications thereof are contemplated as falling within the scope of the present invention, as defined by the appended claims.

What is claimed is:

1. A blending container for mixing a nutritional liquid, comprising:
a cup for holding the liquid and having a base wall;
a cover for a top of the cup;
a strut constructed and arranged for positioning adjacent to the base wall; and
a plurality of blades supported from the strut.

2. The container of claim 1 wherein each of the blades is supported to be spaced apart in a longitudinal direction between the cup and cover.

3. The container of claim 2 wherein each blade is supported in parallel with all other blades.

4. The container of claim 3 wherein all blades are planar and extend in parallel planes to the base wall of the cup.

5. The container of claim 4 wherein each blade is substantially rectangular in shape.

6. The container of claim 5 wherein each blade has rounded corners.

7. The container of claim 1 including a pulley mechanism disposed over the base wall of the cup and for controlling a spinning of the strut.

8. The container of claim 7 wherein all blades are planar and are supported in parallel to each other.

9. The container of claim 8 including a pull handle for controlling the pulley mechanism.

10. The container of claim 9 including a string connected between the pulley mechanism and the pull handle.

11. The container of claim 10 wherein each of the blades is supported to be spaced apart in a longitudinal direction between the cup and cover.

12. The container of claim 11 wherein all blades are planar and extend in parallel planes to the base wall of the cup.

13. The container of claim 12 wherein each blade is substantially rectangular in shape.

14. The container of claim 13 wherein each blade has rounded corners.

15. A blending container for mixing a nutritional liquid, comprising:
a cup for holding the liquid and having a base wall;
a cover for a top of the cup;
a strut constructed and arranged for positioning adjacent to the base wall;
at least one blade supported from the strut; and
a pulley mechanism disposed over the base wall of the cup and coupled to and for controlling a spinning of the strut.

16. The container of claim 15 wherein all blades are planar and are supported in parallel to each other.

17. The container of claim 16 including a pull handle for controlling the pulley mechanism.

18. The container of claim 17 including a string connected between the pulley mechanism and the pull handle.

19. The container of claim 18 wherein all blades are planar and extend in parallel planes to the base wall of the cup.

20. The container of claim 12 wherein each blade is substantially rectangular in shape, and each blade has rounded corners, a strut housing for supporting the strut, said pulley mechanism being rotatable relative to the strut housing and disposed below the strut, said pulley mechanism having a diameter that is greater than the diameter of the strut, bearing means between the strut and strut housing, said strut housing having a somewhat elongated recess in a sidewall thereof, said handle having an elongated shape for fitting within the elongated recess, said pullet mechanism having a base with a pulley segment and an overlying top from which the strut is supported, said top being of a smaller diameter than the diameter of the pulley segment, and a bottom wall that rests on the cup base wall, said bottom wall including a center post received in a center hole provided in pulley segment, said handle having a rest position spaced apart from the pulley segment, and a string connected between the pulley mechanism and the pull handle extending across a gap between the handle and pulley segment.
